(19) United States
(12) Patent Application Publication
(10) Pub. No.: US 2024/0117963 A1
(43) Pub. Date: Apr. 11, 2024

(54) LUMINAIRE FOR USE WITH A MAILBOX

(71) Applicant: David Sherman, Niagara on the Lake (CA)

(72) Inventor: David Sherman, Niagara on the Lake (CA)

(73) Assignee: David Sherman, Niagara on the Lake (CA)

(21) Appl. No.: 18/113,658

(22) Filed: Feb. 24, 2023

Related U.S. Application Data
(60) Provisional application No. 63/413,289, filed on Oct. 5, 2022.

(51) Int. Cl. F21V 33/00; F21S 9/03; F21V 21/10; G09F 13/04; H02S 40/38

(52) U.S. Cl. CPC F21V 33/006; F21S 9/037; F21V 21/10; G09F 13/0413; H02S 40/38; F21Y 2115/10

(57) ABSTRACT

Disclosed is a luminaire that attaches to a mailbox to illuminate the address number of a building. The luminaire includes a housing, one or more light sources, such as LED, incandescent, fluorescent, etc. The light sources can be electrified in various ways, such as solar, high voltage AC, low voltage DC. The housing has various holes to accommodate one or more mounting brackets and mounting accessories. Also, a plurality of numbers and letters to attach to the housing to indicate the address number.

### TECHNICAL FIELD

The presently disclosed embodiments are related, in general, to a luminaire for use with a mailbox. More particularly, the presently disclosed embodiments are related to a luminaire that is attached to a mailbox to illuminate the address number of a budding.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Candles, kerosene lanterns, fires, and other combustion-based lighting sources are inherently unsafe and unsuitable for a wide range of lighting requirements. The majority of non-combustible-based electrical and lighting sources can be powered by batteries, solar power, wind power, and the electrical grid.

Electrical and lighting systems that use batteries must be continually checked for battery life. The user runs the danger of being without power when the battery runs out if such electrical and lighting devices are located in an area that is difficult to reach. Additionally, when batteries approach their end of life, they naturally lose output current Lighting lumen output is lowered as a result. Battery-powered electrical systems are also vulnerable to theft if they are not installed permanently.

Solar-powered electrical and lighting systems require a storage battery(s) to store energy when being charged by the solar panels. Once the electrical circuit is powered on, the battery's charge is exhausted as needed. The amount of charge in a battery received from a scalar power source is dependent upon many factors including but not limited to the positioning of the solar panel(s), amount of direct sunlight, number of hours of direct sunlight, the efficiency of the Solar panel(s), size of the solar panel(s) etc. In addition, rechargeable battery(s) have a life based on the number of charges they receive, Most of them will operate properly for approximately 1000 charges, which means approximately three (3) years, after which they may need replacement. This issue needs to be monitored by the user.

Wind-powered electrical and lighting systems also require storage battery(s) that then power an electrical circuit. Most wind-powered systems are of largescale commercial installations costing huge amounts of money. Installation of a wind system is very intricate and involves professional installers and engineers. Hence wind-powered electrical and lighting systems are not suitable for household or light commercial or light industrial use.

When it comes to powering electrical and lighting equipment, the electrical grid's current is by far superior. Lighting systems can use any of the following types of lighting: gas discharge, high-intensity discharge, fluorescent, electroluminescent, incandescent, and LED (light-emitting diode). When compared to illumination supplied by batteries, solar panels, or wind, higher delivered lumens are possible. However, the high-power wire must be connected to the electrical or lighting systems from a building's electrical system or the electrical grid to run such electrical systems. This could be costly if the electrical or lighting systems are outside, far from the building, or disconnected from the electrical grid. If outside, the wiring needs to be covered with an approved electrical covering and buried in the ground in an approved conduit. As a result, this source of electricity is not the ideal choice for many applications.

This specification recognizes that there is a need for a luminaire for illuminating a building's address numbers so that visitors can easily see the address number in the darkness of nighttime. Further, there is a need for a luminaire that can provide one or more choices of electrification, wherein the choices of electrification include 1) high voltage powered, 2) low voltage powered, and 3) solar powered.

Thus, in view of the above, there is a long-felt need in the industry to address the deficiencies and inadequacies.

Further limitations and disadvantages of conventional approaches will become apparent to one of skill in the art, through the comparison of described systems with some aspects of the present disclosure, as set forth in the remainder of the present application and with reference to the drawings.

### SUMMARY

According to embodiments illustrated herein, there may be provided a luminaire for use with a mailbox to illuminate the address number of a building.

Accordingly, one aspect of they present invention is to provide a luminaire that includes a housing, one or more solar panels, a plurality of light-emitting diodes (LEDs), one or more rechargeable batteries, at least two diffuser lenses, and a solar charge controller. The housing has various holes to accommodate one or more mounting brackets. The solar panels absorb energy from sunlight and convert the energy into DC electricity. The light-emitting diodes (LEDs) are positioned to illuminate the diffuser lenses. The rechargeable battery(s) store the DC electricity to power the LEDs. The solar charge controller controls the flow of DC electricity to the rechargeable battery(s) and the LEDs.

In an aspect, t housing optionally includes an on off switch to control the operation of the solar-powered luminaire.

In an aspect, the housing, optionally includes a solar charge controller programmed to facilitate the user to select between a plurality of color temperatures, a plurality of colors, and a plurality of LED functions (such as flashing, pulsing, fading, etc.) by using a remote control.

In an aspect, the luminaire further includes a plurality of numbers and letters removably attached to one or more of: the housing, and the diffuser lenses.

In an aspect, the luminaire further includes a removable mounting bracket.

In an aspect, the luminaire further includes a photocell and at least one solar charge controller. The photocell is programmed within the solar charge controller configured to sense natural light levels.

In an aspect, the solar charge controller is configured to: receive signal regarding the natural light level sensed by said photocell, compare the natural light level with a predetermined light level; and output a signal to increase or decrease the light provided by said LEDs depending upon the natural light level sensed by said photocell.

Accordingly, one aspect of the present invention is to provide a luminaire that includes at least two diffuser lenses, a light source, and a terminal block. The light source includes one or more lampholders to accommodate lamps that illuminate the diffuser lenses. The terminal block attaches high-voltage input wires from an electrical circuit.

In an aspect, the housing optionally includes an in/off switch to control an operation of the luminaire.

In an aspect, the housing optionally includes a timing switch to regulate the illuminated period of time of the luminaire.

In an aspect, the luminaire further includes a plurality of numbers and letters removably attached to the one or spore of; the housing, and the diffuser lenses.

In an aspect, the luminaire includes a removable mounting bracket.

In an aspect, the luminaire optionally includes a photocell. The photocell is configured to sense natural light levels.

The light level sensed by said photocell; compares the natural light level with a predetermined light level; and turns on or off the electricity flowing from the terminal block to lampholders, depending upon the natural light level sensed by said photocell.

Accordingly, one aspect of the present invention is to provide a luminaire that includes a housing, one or more light sources, a step-down transformer, at least two diffuser lenses, and a terminal block. The housing has various holes to accommodate one or more mounting brackets. The light sources are positioned to illuminate the diffuser lenses. The step-down transformer reduces the incoming voltage as determined by a light source. The terminal block attaches high-voltage input wires from an electrical circuit.

In an aspect, the housing optionally includes an on/off switch to control an operation of the luminaire.

In an aspect, the housing optionally includes a timing switch to regulate the illuminated time of the luminaire.

In an aspect, the housing optionally includes an LED controller with a remote control to alter the color temperature, colors, and functions (such as flashing, pulsing, fading, etc.) of the LED array.

In an aspect, the luminaire further includes a plurality of numbers and letters removably attached to the one or more of the housing, and the diffuser lenses.

In an aspect, the luminaire further includes a removable mounting bracket.

In an aspect, the luminaire further includes a photocell configured to sense natural light level.

In an aspect, the natural light level sensed by said photocell; compares the natural light level with a predetermined light level; turns on or off the electricity flowing from the step-down transformer to lampholders or to LED controller, as the case may be, depending upon the natural light level sensed by said photocell.

Accordingly, one aspect of the present invention is to provide a luminaire that includes a housing, one or more light sources, an in line step-down transformer, and at least two diffuser lenses. The housing has various hardware and accessories for use with a mailbox. The light sources are positioned to illuminate the diffuser lenses. The in line step-down transformer reduces the incoming voltage as determined by a light source.

In an aspect, the housing optionally includes on/off switch to control an operation of the luminaire.

In an aspect, the housing optionally includes timing switch to regulate the illuminated period of time of the luminaire.

In an aspect, the housing, optionally includes an LED controller with a remote control to alter the color temperature, colors, and functions (such as flashing, fading, pulsing, etc.) of the LED array.

In an aspect, the luminaire further includes a plurality of numbers and letters removably attached to the one or more of: the housing, and the diffuser lenses.

In an aspect, the luminaire further includes a photocell configured to sense natural light level.

In an aspect, the natural light level sensed by said photocell; compares the natural light level with a predetermined light level; turns on or off the electricity flowing from the in line step-down transformer to LED controller, depending upon the natural light level sensed by said photocell.

In an aspect, the luminaire provides one or more choices of electrification, wherein the choices of electrification include 1) solar powered 2) high voltage powered, and 3) low voltage powered. Further, the present invention embodies a two-sided lighting system and provides the ability to attach the luminaire directly to a mailbox.

Accordingly, one advantage: of the present invention is that each choice of electrification has benefits based on the location of the mailbox relative to the location of the building and based on the cost of installation, as required.

In an aspect, a high voltage powered system is desirable if the distance from the building is more than 100 feet as a low voltage system may experience a voltage drop at the position of the luminaire. Thus, the illumination is inferior to high voltage systems. High voltage power is superior to solar power as it is guaranteed constant electricity producing, full brightness of t luminaire throughout the night, notwithstanding the amount of sunlight during the day. However, the disadvantage of high-voltage power is the high installation cost due to local electrical standards or regulations. Further, it is more difficult to install a high-voltage powered system if the mailbox is already permanently installed.

In an aspect, a low voltage powered system (48 volts or less) is safe to operate outdoors, and the electrical wiring does not need to be buried underground as does high voltage applications. It is simple to install. It can be plugged in or connected into a standard building's electrical system and the wiring can be laid safely on the ground. However, the disadvantage is that the longer the distance from the electrical outlet the more voltage drop, which can cause low illumination levels.

In an aspect, a solar-powered system is useful where the household electrical system is far from the location of the mailbox and the cost is prohibitive to install a high-voltage system due to the requirements of the local electrical standards or regulations. In another application, a low-voltage luminaire may also be too far away from a household electrical system. Thus, solar power would be the best choice.

In an aspect, the luminaire connects to an electrical system.

These and other features and advantages of the present disclosure may be appreciated from a review of the following detailed description of the present disclosure, along with the accompanying figures in which reference numerals refer to like parts throughout.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, of other shapes) in the figures represent one example of the boundaries. In some examples, one element may be designed as multiple elements, or multiple elements may be designed as one element. In some examples, an element shown as an internal component of one element may be implemented as an external component in another and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 illustrates a perspective view of a solar-powered luminaire to illuminate a building's address number(s), in accordance with at least one embodiment.

FIG. 2 is a schematic drawing of the internal electrical components of the solar-powered luminaire in accordance with at least one embodiment.

FIG. 3 illustrates a perspective view of a typical mailbox mounted on a post, embodying a solar-powered luminaire to illuminate a building's address number(s), in accordance with at least one embodiment.

FIG. 4 illustrates a rear view of a typical mailbox, mounted on an arm attached to a post embodying a solar-powered luminaire to illuminate a building's address number(s), in accordance with at least one embodiment.

FIG. 5 illustrates a side view of a typical mailbox, mounted on an arm attached to a post, embodying a solar-powered luminaire to illuminate a building's address number(s), in accordance with at least one embodiment.

FIG. 6 illustrates a perspective view of an additional design of a solar-powered luminaire to illuminate a building's address number(s), in accordance with at least one embodiment.

FIG. 7 illustrates a perspective view of a typical mailbox, mounted on a post, embodying an additional design of a solar-powered luminaire to illuminate a building's address number(s), in accordance with at least one embodiment.

FIG. 8 illustrates a rear view of a typical mailbox, mounted on an arm attached to a post, embodying an additional design of a solar-powered luminaire to illuminate a building's address number(s), in accordance with at least one embodiment.

FIG. 9 illustrates a side view of a typical mailbox, mounted on an arm attached to a post, embodying an additional design of a solar-powered luminaire to illuminate a building's address number(s), in accordance with at least one embodiment.

FIG. 10 illustrates a perspective view of a high-voltage luminaire to illuminate a building's address number(s), in accordance with at least one embodiment.

FIG. 11A is a schematic drawing of the electrical components enclosed in the housing, with embodied on/off switch and photocell that are housed internally in a high voltage powered luminaire to illuminate a building's address member (s), in accordance with at least one embodiment.

FIG. 11B is a schematic drawing of the electrical components with an embodied timer switch that is housed internally in a high voltage powered luminaire to illuminate a building's address Member (s), in accordance with at least one embodiment.

FIG. 12 illustrates a perspective view of a typical mailbox, mounted on a post, embodying a high voltage-powered luminaire to finale a building's address number(s), in accordance with at least one embodiment.

FIG. 13 illustrates a side view of a typical mailbox, mounted on a post, embodying a high voltage-powered luminaire to illuminate a building's address number(s), in accordance with at least one embodiment.

FIG. 14 illustrates a side view of a typical mailbox, mounted on an arm attached to a post embodying a high voltage powered luminaire to illuminate a building's address number(s), in accordance with at least one embodiment.

FIG. 15 illustrates a perspective view of a low-voltage luminaire to illuminate a building's address number(s), in accordance with at least one embodiment.

FIG. 16A is a schematic drawing of the electrical components enclosed in the housing; of a low-voltage luminaire to illuminate a building's address number (s), with embodied on/off switch lampholder(s), and photocell, in accordance with at least one embodiment,

FIG. 16B is a schematic drawing of the electrical components enclosed in the housing of a low-voltage luminaire to illuminate a building's address number (s), with an embodied timer switch, and lampholder(s), in accordance with at least one embodiment.

FIG. 16C is a schematic drawing of the electrical components enclosed in the housing of a low-voltage luminaire to illuminate a building's address number (s), with embodied on oft switch, LED controller, and photocell, in accordance with at least one embodiment.

FIG. 16D is a schematic drawing of the electrical components enclosed in the housing of a low-voltage luminaire to illuminate a building's address number (s), with an embodied timer switch, and LED controller, n accordance with at least one embodiment.

FIG. 17 illustrates a perspective view of a typical mailbox, mounted on a post, embodying a low voltage powered luminaire to illuminate a building's address number(s), in accordance with at least one embodiment,

FIG. 18 illustrates a rear view of a typical mailbox, mounted on a post, embodying a low voltage powered luminaire to illuminate a building's address number(s), in accordance with at least one embodiment.

FIG. 19 illustrates a side view of a typical mailbox, mounted on an arm attached to a post, embodying a low voltage powered luminaire to illuminate a building's address number(s), accordance with at least one embodiment.

FIG. 20 illustrates a perspective view of an additional design of a low voltage powered luminaire to illuminate a building's address number(s), in accordance with at least one embodiment.

FIG. 21A is a schematic drawing of the internal electrical components of the additional design of a low-voltage powered luminaire with embodied on/off switch and photocell to illuminate a building's address number (s), in accordance with at least one embodiment.

FIG. 21B is a schematic drawing of the internal electrical components of the additional design of a low-voltage powered luminaire with embodied timing switch to illuminate a building's address number (s), in accordance with at least one embodiment.

FIG. 22 illustrates a perspective view of a typical mailbox, mounted on a post, embodying an additional design of a low voltage powered luminaire to illuminate a building's address number(s), in accordance with at least one embodiment.

FIG. 23 illustrates a rear view of a typical mailbox, mounted on a post, embodying additional design of a low voltage powered luminaire to illuminate a building's address number(s), in accordance with at least one embodiment.

FIG. 24 illustrates a side view of a typical mailbox, mounted on an arm attached to a post, embodying an additional design of a low voltage powered luminaire to illuminate a building's address number(s), in accordance with at least one embodiment.

### DETAILED DESCRIPTION

The present disclosure may be best understood with reference to the detailed figures an d description set forth herein. Various embodiments are discussed below with reference to the figures. However, those skilled in the art will readily appreciate that the detailed descriptions given herein with respect to the figures are simply for explanatory purposes as the luminaires, methods, and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

As described in the background and summary section of this specification, there has long been a need for illuminating a building's address numbers so that visitors can easily see the address number in the darkness of nighttime. Currently, most illuminated address number systems are attached to a wall on the building or attached to a ground stake placed somewhere in the front of the property facing the road. In all known systems there is only one side illuminating the address numbers. This is a flawed technique because if it were erected parallel to the structure, it would be impossible to see as one approached from the sides. Instead, one would need to stand in front of the building to view the numbers. In the case that the system is positioned perpendicular to the building, only one side is illuminated, thus when approached from the non-illuminated side it becomes useless. Many buildings have a mailbox positioned very close to the road to facilitate the ail delivery person to deliver the mail without the need to get out of their vehicle or as dictated by the local postal authority. These mailboxes do not have illuminated address numbers attached thereto. Many users simply apply stickers to the side of the mailbox to identify their building's address numbers. At night it is almost impossible to see these address numbers. The luminaire of the present invention solves this problem by attaching to an installed mailbox, or a new mailbox, thereby illuminating the address numbers on both sides, thus allowing the numbers to be seen by approaching persons or vehicles from either side.

A person skilled in the art will understand that the luminaire is described herein for illustrative purposes and should not be construed to limit the scope of the disclosure.

The present specification provides a luminaire and method for use with a mailbox, to illuminate the address number of a building. In an embodiment, the luminaire provides one or more choices of electrification, wherein the choices of electrification include 1) solar powered 2) high voltage powered, and 3) low voltage powered. Further, the present invention embodies a two-sided lighting system and provides the ability to attach the luminaire directly to a mailbox.

Accordingly, one or more aspects of the present invention are to provide a luminaire with an embodied attachment system that includes one or more of housings, diffuser lenses, backplates, additional enclosures, wiring, electrical components, switches, mounting brackets, mounting hardware, and other accessories. In an embodiment, the housing is made of plastic, metal, or other suitable material. Further, the housing may be of any size or shape. Additionally, the lighting system, embodied in the luminaire contains one or a plurality of LEDs, lampholders, and other suitable forms of lighting.

In an embodiment, the present luminaire includes a mounting bracket and mounting hardware to attach the luminaire to a mailbox. In an embodiment, the luminaire includes one or more rechargeable batteries or will attach to a building's electrical system.

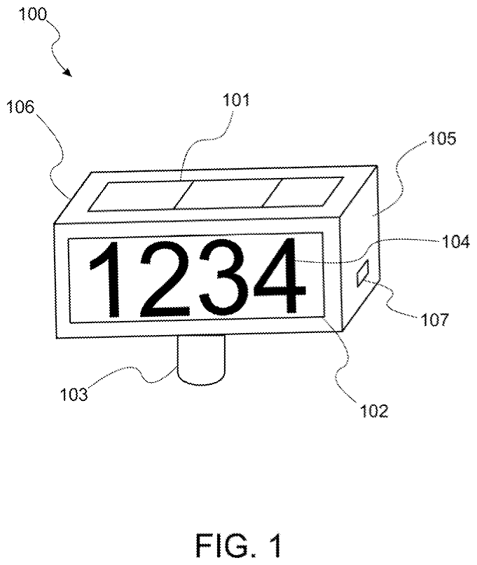

FIG. 1 illustrates a perspective view 100 of a solar-powered luminaire used to illuminate a building's address number (s), in accordance with at least one embodiment. FIG. 1 depicts a solar panel 101, a diffuser lens 102, a mounting bracket 103, user-applied address number (s) 104, internal electrical components 105, a housing 106, and an on/off switch 107. Further, the luminaire includes a plurality of light-emitting diodes (LEDs), one or more rechargeable batteries, and a solar charge controller. The housing 106 has various holes to accommodate one or more mounting brackets. The solar panels 101 absorb energy from sunlight and convert the energy into DC electricity. The light-et pitting diodes (LEDs) are positioned to illuminate the diffuser lenses 102. The rechargeable battery(s) store the DC electricity to power the LEDs. The solar charge controller controls the flow of DC electricity to the rechargeable battery(s) and the LEDs.

In an embodiment, the housing 106 optionally includes an on/off switch to control the operation of the solar-powered luminaire. In an embodiment, the housing 106 includes a solar charge controller and control configured to facilitate the user to select between a plurality of color temperatures, light output colors, and lighting functions (such as flashing, pulsing, fading, etc.).

In an embodiment, the luminaire further includes a plurality of numbers and letters removably attached to one or more of: the housing 106, and the diffuser lenses. In an embodiment, the luminaire further includes a removable mounting bracket. In an embodiment, the luminaire further includes a photocell The photocell is programmed within the solar charge controller configured to sense natural light levels. In an embodiment, the solar charge controller is configured to; receive a signal regarding the natural light level sensed by said photocell; compare the natural light level with a predetermined light level; and output a signal to increase or decrease the light provided by said LEDs depending upon the natural light level sensed by said photocell.

FIG. 1 illustrates a perspective view 100 of a solar-powered luminaire used to illuminate a building's, address number (s), in accordance with at least one embodiment. FIG. 1 depicts a solar panel 101, a diffuser lens 102, a mounting bracket 103, user-applied address number (s) 104, internal electrical components 105, a housing 106, and an on/off switch 107.

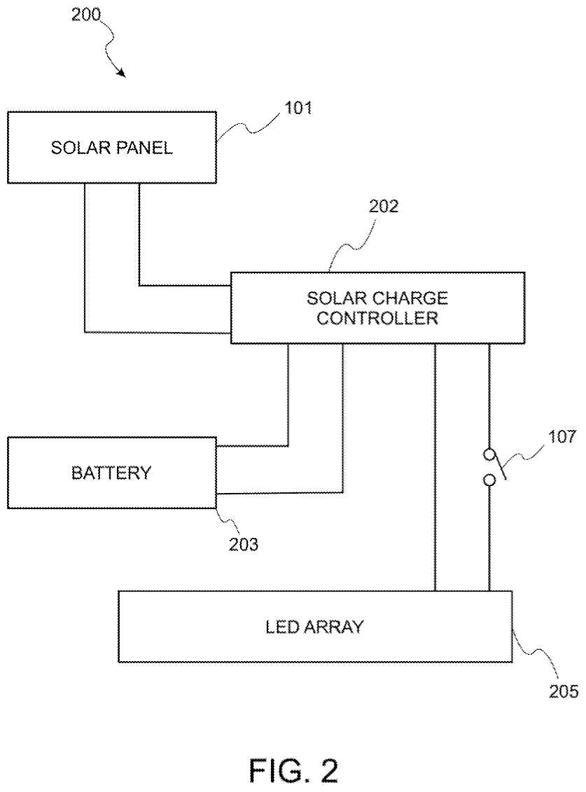

FIG. 2 is a schematic drawing 200 of the electrical components internally situated in the housing, in accordance with at least one embodiment. FIG. 2 depicts a solar panel 101, an on/off switch 107, a solar charge controller 202, a rechargeable battery 203, and an LED array 205.

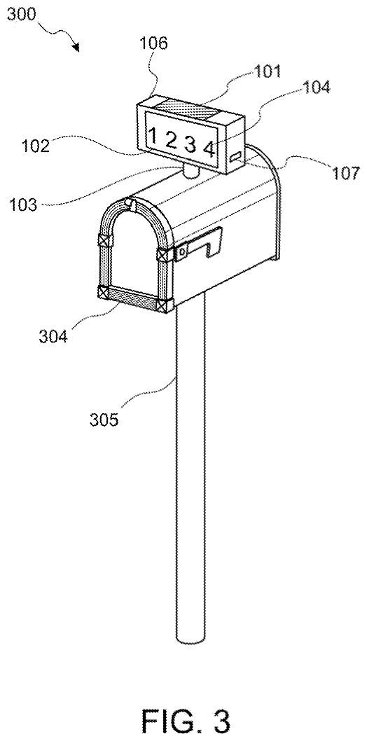

FIG. 3 illustrates a perspective view 300 of a typical mailbox, mounted on a post, embodying a solar-powered luminaire to illuminate a building's address number(s), in accordance with at least one embodiment. FIG. 3 depicts a flat solar panel 101, a diffuser lens 102, a mounting bracket 103, user-applied address number (s) 104, a housing 106, an on/off switch 107, a typical mailbox 304, and a typical mailbox post 305.

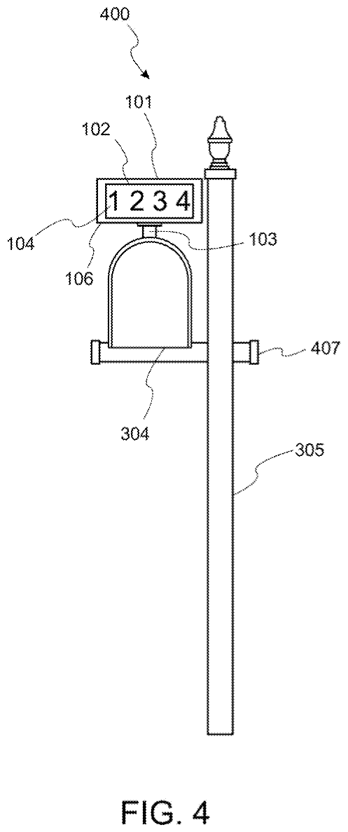

FIG. 4 illustrates a rear view 400 of a typical mailbox, mounted on a post, embodying a solar-powered luminaire to illuminate a building's address number(s), in accordance with at least one embodiment. FIG. 4 depicts a flat solar panel 101, a diffuser lens 102, a mounting bracket 103, user-applied address number (s) 104, a housing 106, a typical mailbox 304, a typical mailbox post 305, and a typical post arm 407.

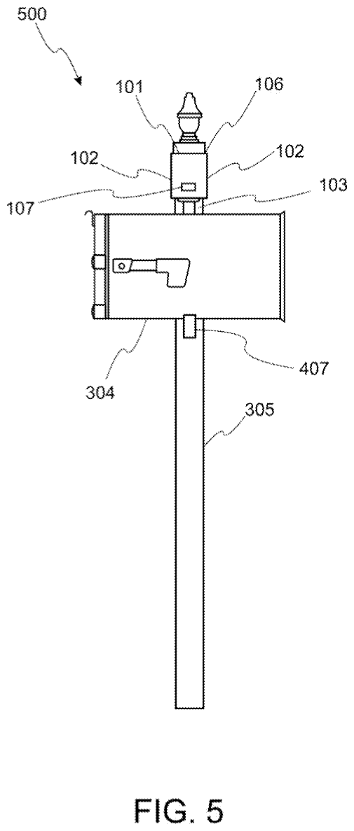

FIG. 5 illustrates a side view 500 of a typical mailbox, mounted on an arm attached to a post, embodying a solar-powered luminaire to illuminate a building's address number(s), in accordance with at least one embodiment. FIG. 5 depicts a flat solar panel 101, diffuser lenses 102, a mounting bracket 103, a housing 106, an on/off switch 107, a typical mailbox 304, a typical mailbox post 305, and a typical post arm 107.

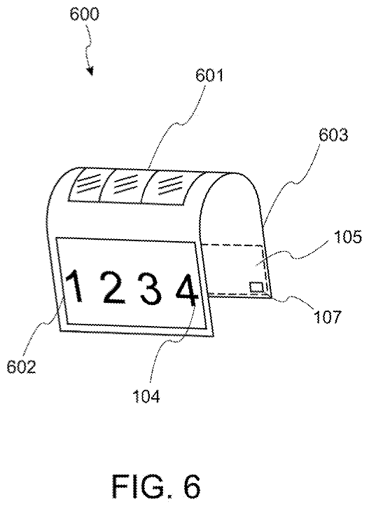

FIG. 6 illustrates a perspective view 600 of an additional design of a solar-powered luminaire to illuminate a building's address number(s), in accordance with at least one embodiment. FIG. 6 depicts user-applied address number (s) 104, internal electrical components 105, an on/off switch 107, a curved solar panel 601, a diffuser lens 602, and a housing 603.

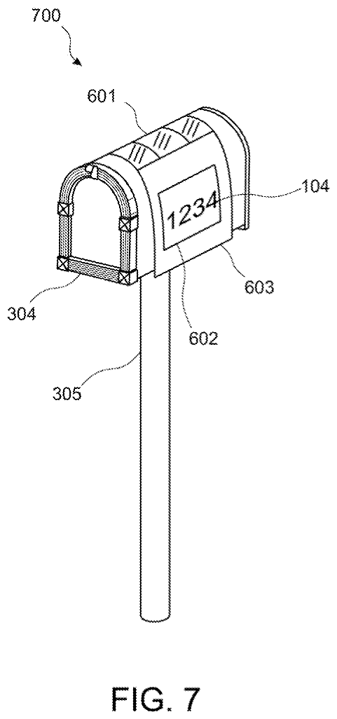

FIG. 7 illustrates a perspective view 700 of a typical mailbox, mounted on a post, embodying an additional design of a solar-powered luminaire to illuminate a building's address number(s), in accordance with at least one embodiment. FIG. 7 depicts user-applied address number (s) 104, a typical mailbox 304, and a typical mailbox post 305, a curved solar panel 601, a diffuser lens 602, and a housing 603.

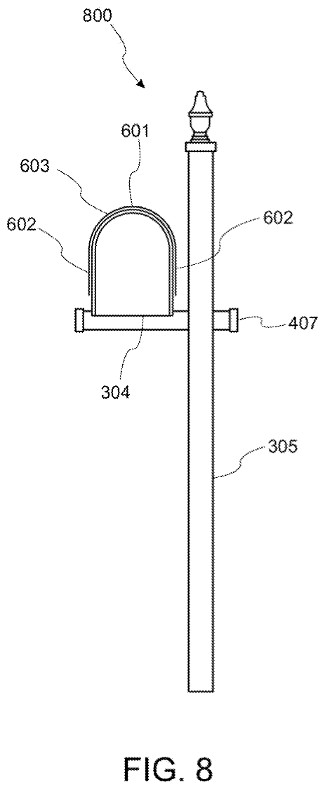

FIG. 8 illustrates a rear view 800 of a typical mailbox, mounted on a typical post arm attached to a post, embodying; an additional designed solar-powered luminaire to illuminate a building's address number(s), in accordance with at least one embodiment, FIG. 8 depicts a typical mailbox 304, a typical mailbox post 305, a typical post arm 407, a curved solar panel 601, diffuser lenses 602, and a housing 603.

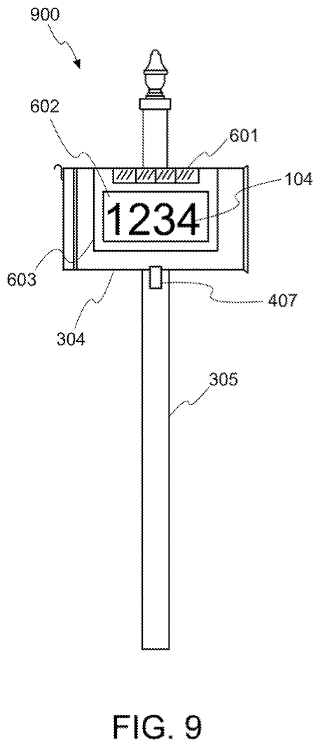

FIG. 9 illustrates a side view 900 of a typical mailbox, mounted on an arm attached to a post, embodying an additional designed solar-powered luminaire to illuminate a building's address number(s), in accordance with at least one embodiment. FIG. 9 depicts user-applied address number(s) 104, a typical mailbox 304, a typical mailbox post 305, a typical post arm 407, a curved solar panel 601, a diffuser lens 602, and a housing 603,

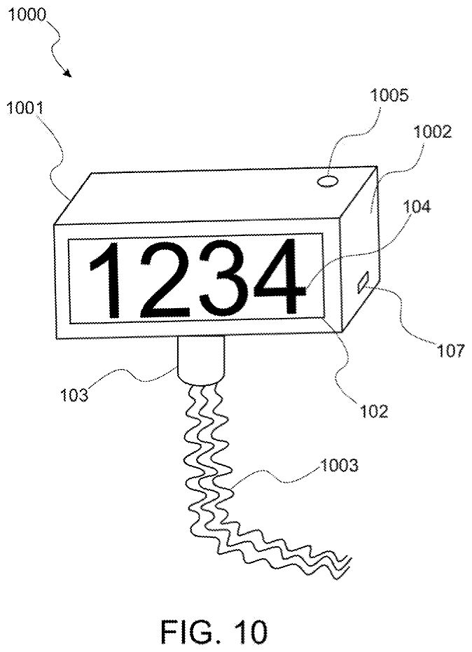

FIG. 10 illustrates a perspective view 1000 of a high voltage powered luminaire to illuminate a building's address number(s), in accordance with at least one embodiment. FIG. 10 depicts a diffuser lens 102, a mounting bracket 103, user-applied address number (s) 104, an on Doff switch 107, a housing 1001, internal electrical components 1002, high voltage input wires 1003 and a photocell 1005. The high voltage-powered luminaire includes at least two diffuser lenses, a light source, and a terminal block. The light source includes one or more lampholders to accommodate lamps that illuminate the diffuser lenses. The terminal block attaches high-voltage input wires from an electrical circuit. In an embodiment, the housing optionally includes an on/off switch to control an operation of the luminaire. In an embodiment, the housing optionally includes a timing switch to regulate the illuminated time of the luminaire.

In an embodiment, the housing optionally includes a timing switch to control the period of time the luminaire is illuminated. In an embodiment, the luminaire further includes a plurality of numbers and letters removably attached to the one or more of: the housing, and the diffuser lenses. In an embodiment, the luminaire includes a removable mounting bracket. In an embodiment, the luminaire further includes a photocell. The photocell is configured to sense natural light levels: compare the natural light level with a predetermined light level; to open or close the flow of electricity from the terminal block to the lampholder(s) depending upon the natural light level sensed by said photocell.

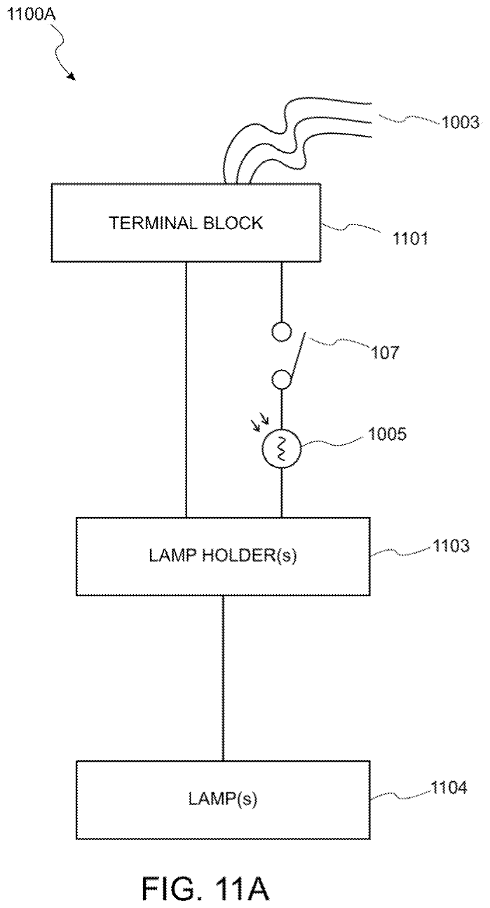

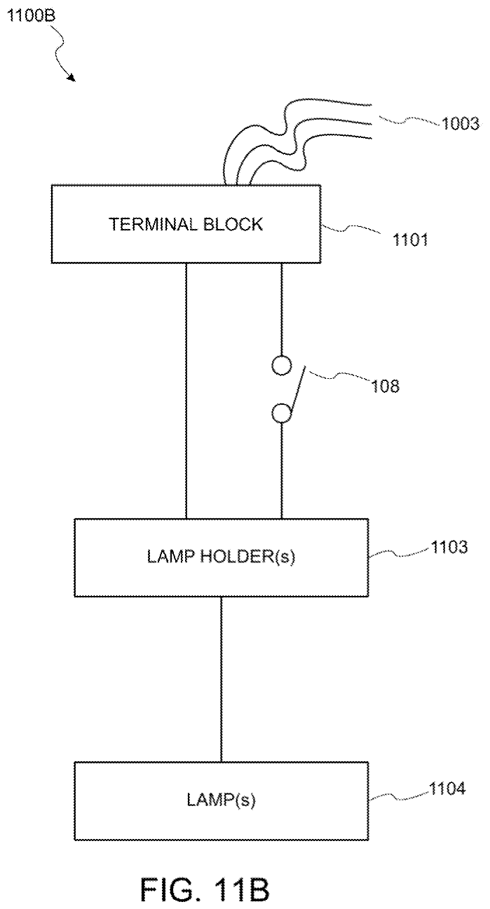

FIG. 11A is a schematic drawing 1100A of the typical internal electrical components of a high-voltage powered luminaire to illuminate a building's address number(s) in accordance with at least one embodiment. FIG. 11A depicts an on/off switch 107, high voltage input wires 1003, a photocell 1005, a terminal block 1101, a lampholder(s) 1103, and a lamp (s) 1104.

FIG. 11B is a schematic drawing 1100B of the typical internal electrical components of a high-voltage powered luminaire to illuminate a building's address number(s), in accordance with at least one embodiment. FIG. 1113 depicts a timing switch 108, high voltage input wires 1003, a terminal block 1101, a lampholder(s) 1103, and a lamp (s) 1104.

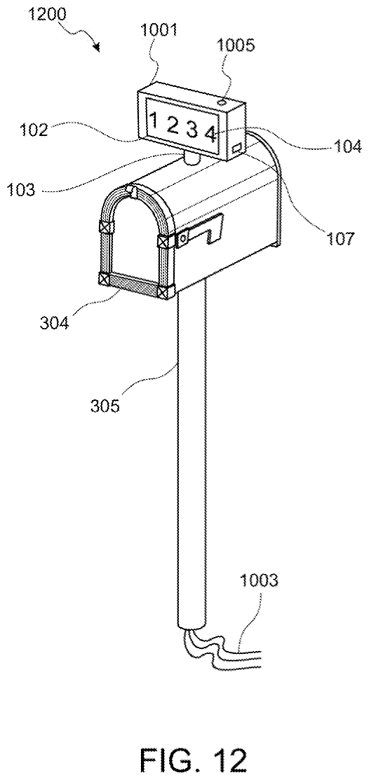

FIG. 12 illustrates a perspective view 1200 of a typical mailbox, mounted on a post, embodying a high voltage powered luminaire to illuminate a building's address number(s), in accordance with at least one embodiment. FIG. 12 depicts a diffuser lens 102, a mounting bracket 103, user-applied address number (s) 104, an on/off switch 107, a typical mailbox 304, a typical mailbox post 305, a housing 1001, high voltage input wires 1003, and a photocell 1005.

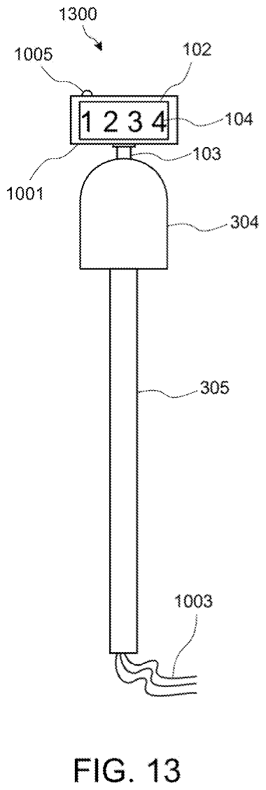

FIG. 13 illustrates a rear view 1300 of a typical mailbox, mounted on a post, embodying a high voltage powered luminaire to illuminate a building's address number(s), accordance with at least one embodiment, FIG. 13 depicts a diffuser lens 102, a mounting bracket 103, user-applied address number (s) 104, a typical mailbox 304, a typical mailbox post 305, a housing 1001, high voltage input wires 1003, and a photocell 1005.

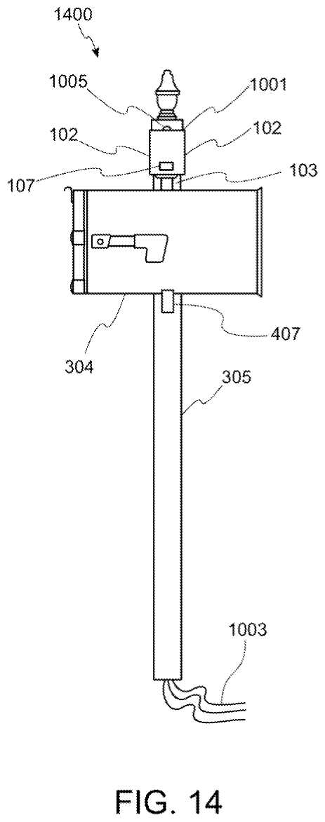

FIG. 14 illustrates a side view 1400 of a typical mailbox, mounted on an arm attached to a post, embodying a high voltage powered luminaire to illuminate a building's address number(s), is accordance with at least one embodiment, FIG. 14 depicts diffuser lenses 102, a mounting bracket 103, an on/off switch 107, a typical mailbox 304, a typical mailbox post 305, a typical post arm 407, a housing 1001, a high voltage input wires 1003 and a photocell 1005.

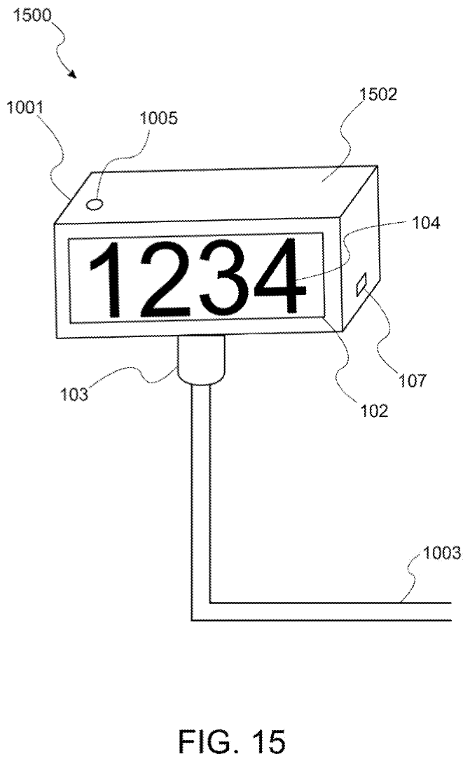

FIG. 15 illustrates a perspective view 1500 of a low voltage powered luminaire to illuminate a building's address number(s), in accordance with at least one embodiment depicts a diffuser lens 102, a mounting bracket 103, user-applied address number (s) 194, an on Doff switch 107, a housing 1001, high voltage input wires 1003, and a photocell 1005. The low-voltage powered luminaire includes one or more of light sources, a step-down transformer, and a terminal block. The housing 1001 has various holes to accommodate one or more mounting brackets 103. The light sources are positioned to illuminate the diffuser lenses. The step-down transformer reduces the incoming voltage as determined by a light source. The terminal block attaches high-voltage input wires from an electrical circuit. In an embodiment, the housing 1001 optionally includes an on/off switch to control the operation of the luminaire. In an embodiment, the housing 1001 optionally includes a timing switch to regulate the illuminated time of the luminaire. In an embodiment the housing 1001 optionally includes an LED controller pith remote control to alter the color temperature, output color, and functions (such as flashing, pulsing, fading, etc.) of the LEDs. In an embodiment, the luminaire further includes a plurality of numbers and letters removably attached to the one or more of: the housing 1001, and the diffuser lenses. In an embodiment, the luminaire further includes a removable mounting bracket. In an embodiment, the luminaire further optionally includes a photocell configured to sense the natural light level; compare the natural light level with a predetermined light level; and turn on or turn off the electricity flowing from the terminal block to the step-down transformer, depending upon the natural light level sensed by said photocell.

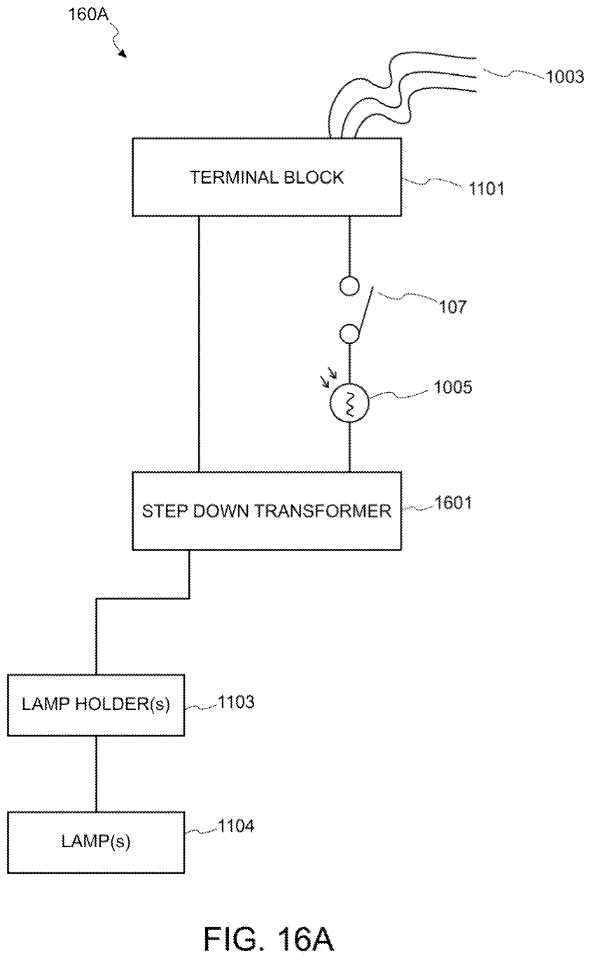

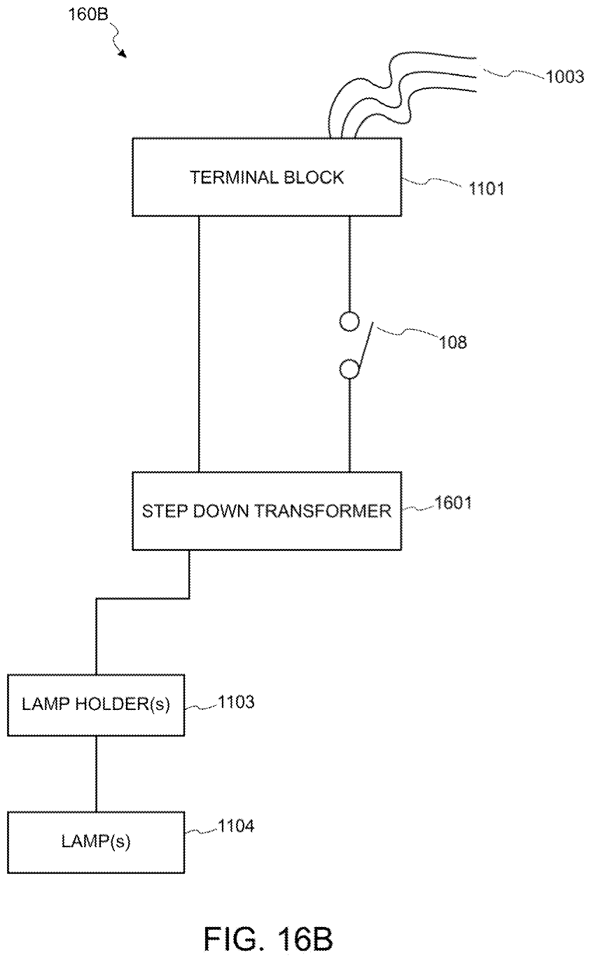

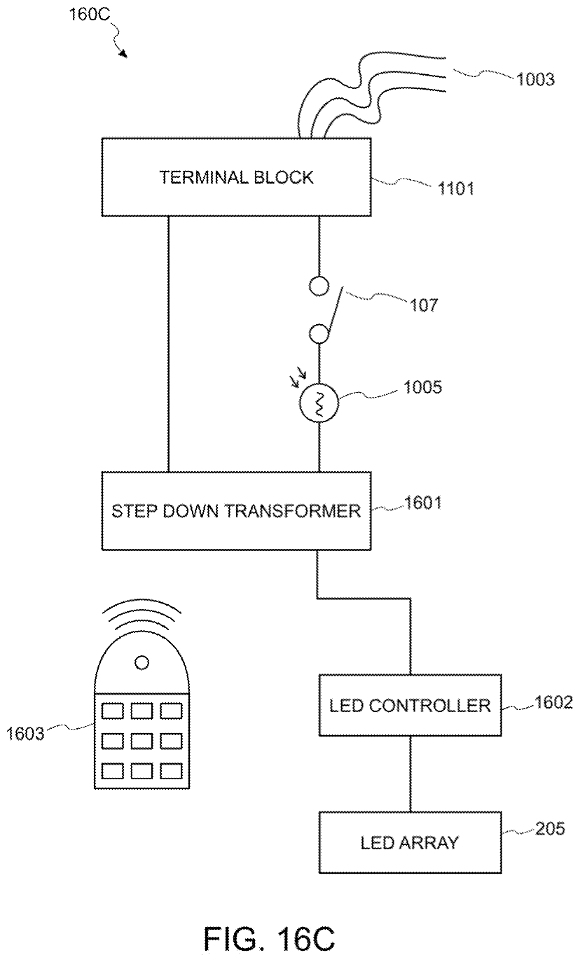

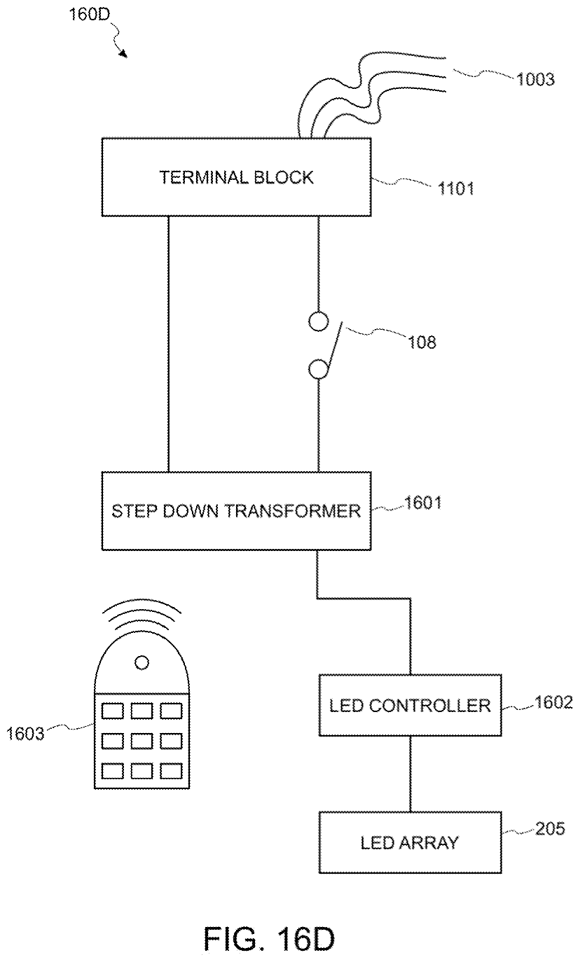

FIG. 1:6A is a schematic drawing 1600A of the typical electrical components housed inside a housing of a low voltage powered luminaire to illuminate a building's address number (s), in accordance with at least one embodiment. FIG. 16A depicts an on/off switch 107, high voltage input wires 1003, a photocell 1005, a terminal block 1101, a lampholder(s) 1103, a lamp (s) 1104, and a step-down transformer 1601.

FIG. 16B is a schematic drawing 16001 of the typical electrical components housed inside a housing of a low voltage powered luminaire to illuminate a building's, address number (s), in accordance with at least one embodiment. FIG. 1613 depicts a timing switch 108, a terminal block 1101, high voltage input wires 1003, a lampholder(s) 1103, a lamp (s) 1104, and a step-down transformer 1601.

FIG. 16C is a schematic drawing 1600C of the typical electrical components housed inside a housing of a low voltage powered luminaire to illuminate a building's address number (s), in accordance with at least one embodiment. FIG. 16C depicts an on/off switch 107, an LED array 205, high voltage input wires 1003, a photocell 1005, a terminal block 1101, a step-down transformer 1601, an LED controller 1602, and a remote control 1603.

FIG. 16D is a schematic drawing 16009 of the typical electrical components housed inside a housing of a low voltage powered luminaire to illuminate a building's address number (s), in accordance with at least one embodiment. FIG. 169 depicts a timing switch 108, an LED array 205, high voltage wires 1003, a terminal block 1101, a step-down transformer 1601, an LED controller 1602, and a remote control 1603.

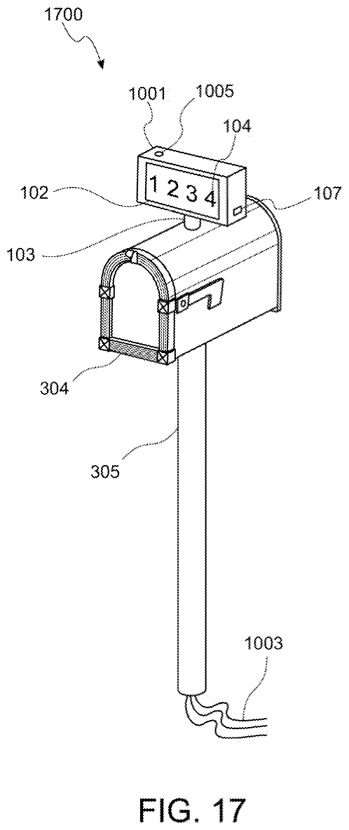

FIG. 17 illustrates a perspective view 1700 of a typical mailbox, mounted on a post, embodying a low voltage powered luminaire to illuminate a building's address number(s), accordance with at least one embodiment. FIG. 17 depicts a diffuser lens 102, a mounting bracket 103, user-applied address number (s) 104, an on/off switch 107, a typical mailbox 304, a typical mailbox post 305, a housing 1001, high voltage input wires 1003, and a photocell 1005.

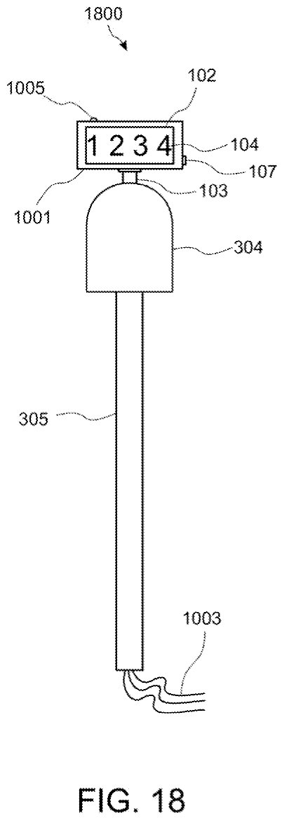

FIG. 18 illustrates a rear view 1800 of a typical mailbox, mounted on a post, embodying a low voltage powered luminaire to illuminate a building's address number(s), in accordance with at least one embodiment. FIG. 18 depicts diffuser lenses 102, a mounting bracket 103, user-applied address number s) 104, an on/off switch 107, a typical mailbox 304, a typical mailbox post 305, a housing 1001, high voltage input wires 1003, and a photocell 1005.

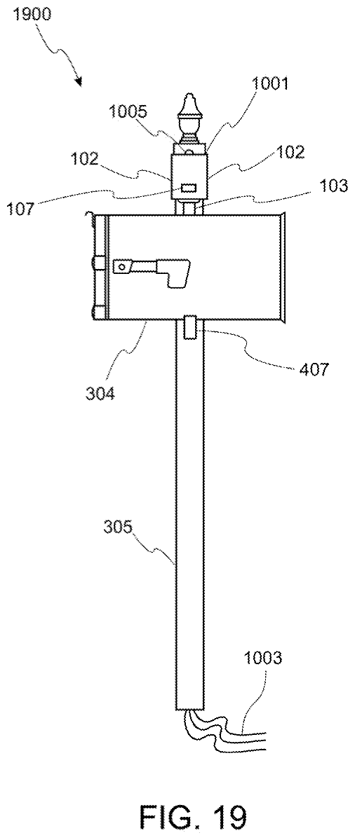

FIG. 19 illustrates a side view 1900 of a typical mailbox, mounted on a typical arm attached to a typical post, embodying, a low voltage powered luminaire to illuminate a building's address number(s), in accordance with at least one embodiment. FIG. 19 depicts diffuser lenses 102, a mounting bracket 103, an on/off switch 107, a typical mailbox 304, a typical mailbox post 305, a typical post arm 407, a housing 1001, high voltage input wires 1003, and a photocell 1005.

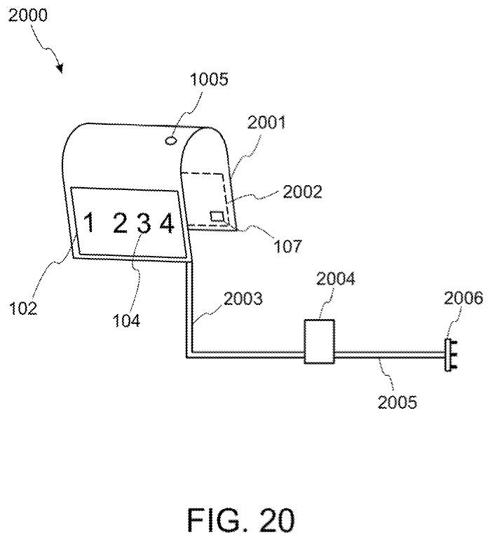

FIG. 20 illustrates perspective view 2000 of an additional design of a low voltage luminaire to illuminate a building's address numbers (s) in accordance with at least one embodiment. FIG. 20 depicts a diffuser lens 102, user applied house number (s) 104, an on/off switch 107, a photocell 1005, a housing 2001, internal electrical components 2002, low voltage wires 2003, an inline step-down transformer 2004, high voltage input wires 2005, and an electrical plug 2006. The housing 2001 optionally includes an on/off switch and a timing switch. The on/off switch controls an operation of the luminaire. The timing switch regulates the period of time the luminaire is illuminated. The light sources are positioned to illuminate the diffuser lenses.

In an embodiment, the luminaire further includes an inline-type step-down transformer to reduce the incoming high voltage from an electrical circuit to the required lower voltage as determined by the light source.

In an embodiment, the luminaire further includes a plurality of numbers and letters removably attached to one or more of: the housing, and the diffuser lenses.

In an embodiment, the luminaire further includes removable mounting hardware.

In an embodiment, the luminaire further includes a photocell and an LED controller. The photocell is configured to sense natural light levels; compare the natural light level with a predetermined light level; and turn on or turn oil flow of electricity from the low voltage wires to the LED controller, depending upon the natural light level sensed by the photocell.

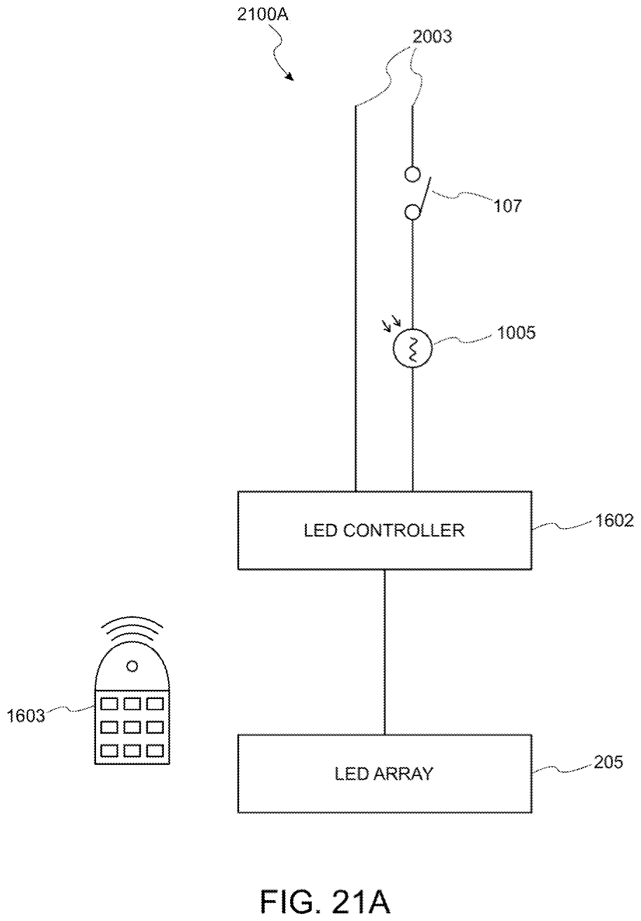

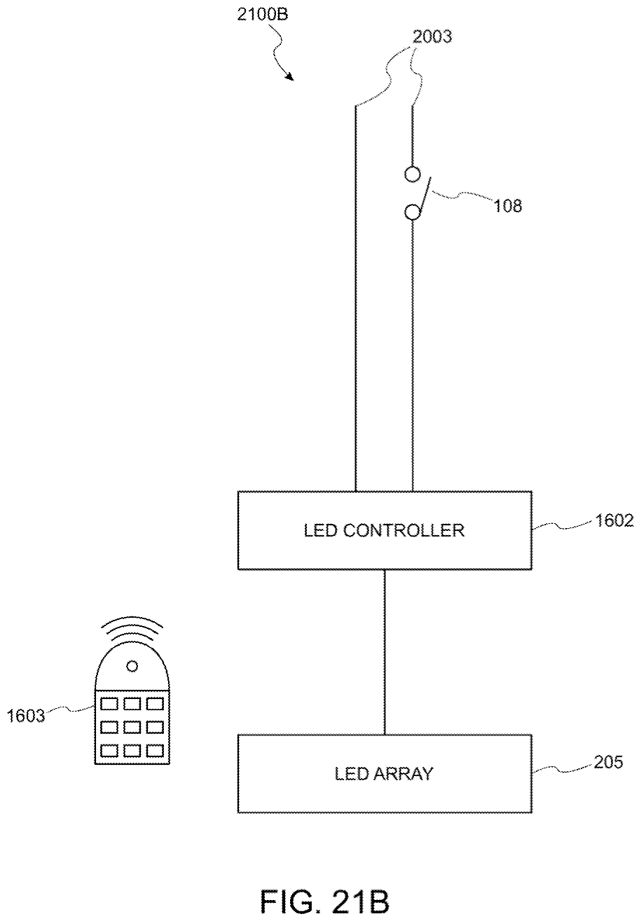

FIG. 21A is a schematic drawing 2100A of the typical internal electrical components of a low-voltage powered luminaire to illuminate a building's address number(s), in accordance with at least one embodiment, FIG. 21A depicts an on/off switch 107, an LED array 205, an LED controller 1602, a remote control 1603, and low voltage input wires 2001.

FIG. 21B is a schematic drawing 2100B of the typical internal electrical components of a low-voltage powered luminaire to illuminate a building's address numbers(s), in accordance with at least one embodiment. FIG. 21B depicts a timing switch 108, an LED array 205, an LED controller 1602, a remote control 1603, and low voltage input wires 2003.

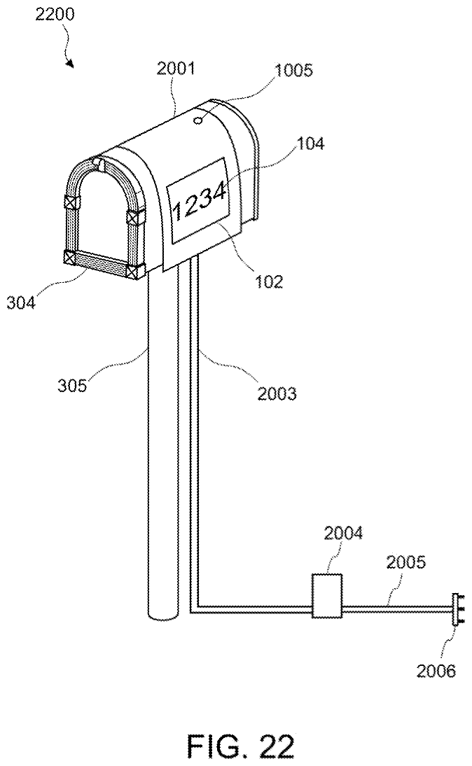

FIG. 22 illustrates a perspective view 2200 of a typical mailbox, mounted on a post, embodying an additional design of a low voltage powered luminaire to illuminate a building's address number(s), in accordance with at least one embodiment, FIG. 22 depicts a diffuser lens 102, user-applied house number (s) 104, a typical mailbox 304, a typical mailbox post 305, a photocell 1005, a housing 2001, low voltage wires 2003, an in line step-down transformer 2004, high voltage input wires, 2005 and an electrical plug 2006.

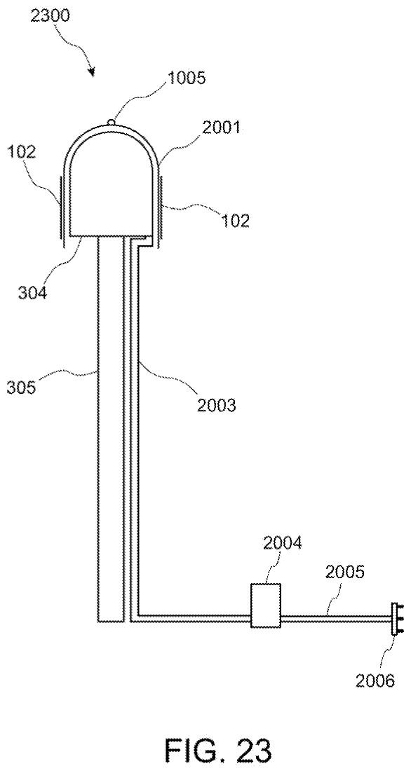

FIG. 23 illustrates a rear view 2300 of atypical mailbox, mounted on a typical post, embodying an additional design of a low voltage powered luminaire to illuminate a building's address number(s), in accordance with at least one embodiment FIG. 23 depicts diffuser lenses 102, a typical mailbox 304, a typical mailbox post 305, a photocell 1005, a housing 2001, low voltage wires 2003, an in-line step-down transformer 2004, high voltage input wires, 2005, and an electrical plug 2006.

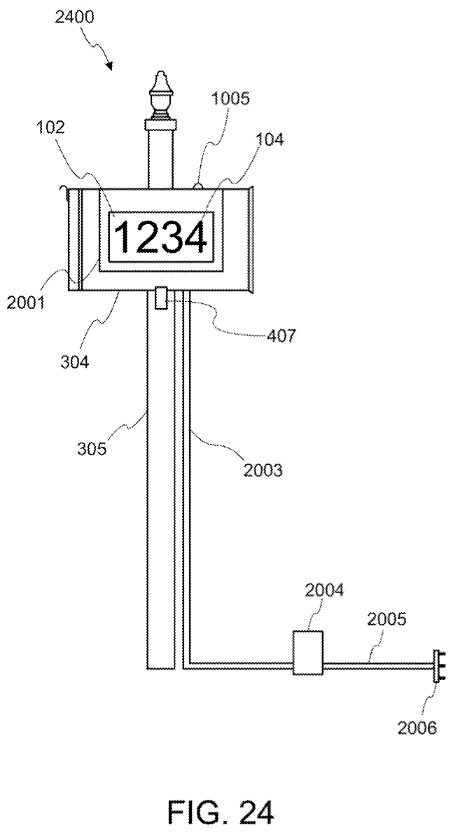

FIG. 24 illustrates a side view 2400 of a typical mailbox, mounted on an arm attached to a post, embodying an additional design of a low voltage powered luminaire to illuminate a building's address numbers), in accordance with at least one embodiment. FIG. 24 depicts a diffuser lens 102, user-applied house number (s) 104, a typical mailbox 304, a typical mailbox post 305, a typical post arm 407, a housing 2001, low voltage wires 2003, an in-line step-down transformer 2004 high voltage input wires, 2005 and an electrical plug 2006.

A person with ordinary skills in the art will appreciate that the luminaires and systems have been illustrated and explained to serve as examples and should not be considered limiting, any manner. It will be further appreciated that the variants of the above-disclosed luminaire, and other features and functions, or alternatives thereof, may be combined to create other different luminaire, systems, or applications.

It should be understood the solar panels 101 and 601 depicted can be constructed from varying materials and in varying sizes, and shapes and have different electrical outputs.

It should be understood the different housing designs 106, 603, 1001, and 2001, as depicted can be constructed from various materials in varying sizes and shapes. In addition, they can contain one or more varying lighting systems and electrical components.

It should be understood the accessories of all kinds used in this luminaire can be constructed from various materials in varying sizes and shapes.

It should be understood the electrical components contained in housings 106, 603, 1001, and 2001 can be constructed from various materials in varying sizes, configurations, designs, constructions, shapes, and electrical components, as required by the light source, light functions, incoming electrical circuits, and designs.

It should be understood the solar charge controller 202, embodied in the subject luminaire, is used to keep the battery from overcharging by regulating the voltage and current coming from the solar panel to the battery. In addition, it contains a photocell. Photocells are devices used to integrate an electric lighting system with a daylighting system so that lights operate only when daylighting is insufficient. A photocell adjusts the light output of as lighting system based on the amount of light it senses. Also, the solar charge controller may embody an on/off switch. The subject controller can be of differing configurations, components, accessories, and functions, as determined by the required electrical parameters and the operation of the subject luminaire and the solar panel 101.

It should be understood the battery(s) 203 embodied in the subject luminaire, can be of varying shapes, sizes, materials, and input and output electrical parameters as determined by the embodied solar charge controller and light source.

It should be understood if an LED array 205 is embodied in the subject luminaire, operating as the light source, it can be of varying shapes, sizes, and input and output electrical parameters as determined by design.

It should be understood if lampholder(s) 1103 and Lamp (s) 1104 are embodied in the subject luminaire, where lamps operate as the light source, they can be incandescent, fluorescent, electroluminescent, LED, high-intensity discharge, gas discharge of varying shapes, sizes, attachment designs, and input and output electrical parameters as determined by the desired light Output, incoming electrical circuit, and design.

It should be understood the step-down transformer 1601 or 2004, if embodied in the subject luminaire, can be of varying shapes, sizes, and input and output electrical parameters as determined by the embodied light source, incoming electrical circuit, and design.

It should be understood the LED controller 1602, if embodied in the subject luminaire, can be of varying shapes, sizes, and input and output electrical parameters as determined by the embodied light source, incoming electrical circuit, and design.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure is not limited to the particular embodiment disclosed, but that the present disclosure will include all embodiments falling within the scope of the appended claims.

What is claimed is:

1. A solar powered luminaire as depicted in FIG. 1, comprising:
a housing with a plurality of holes to accommodate one or more mounting brackets;
one or more solar panels to harvest energy from sunlight and convert the energy into DC electricity;
at least two diffuser lenses;
one or more LEDs (light-emitting diodes) positioned to illuminate the diffuser lenses;
one or more rechargeable batteries to store the DC electricity to power the LEDs; and
a solar charge controller to control the flow of electricity to the rechargeable battery(s) and the LEDs.

2. The luminaire as claimed in claim 1, wherein the housing optionally comprises an on/off switch to control an operation of the solar-powered luminaire.

3. The luminaire as claimed in claim 1, further comprises a plurality of numbers and letters removably attached to one or more of: the housing, or the diffuser lenses.

4. The luminaire as claimed in claim 1, further comprises a removable mounting bracket.

5. The luminaire as claimed in claim 1, further comprises:
a photocell programmed configured to sense natural light level; and
at least one controller configured to:
receive a signal regarding the natural light level sensed by said photocell; compare the natural light level with a predetermined light level; and
output a signal to increase or decrease the light provided by said LEDs depending upon the natural light level sensed by said photocell.

6. A high voltage luminaire as depicted in FIG. 10, comprising:
a housing with mounting hardware and accessories;
at least two diffuser lenses;
a light source consisting of one or more lampholders to accommodate lamps that illuminate the diffuser lenses; and
a terminal block or connector wires to attach high voltage input wires from an electrical circuit.

7. The luminaire as claimed in claim 6, wherein the housing optionally comprises an on/off switch to control an operation of the luminaire, and a timing switch to regulate the period of time the luminaire is illuminated.

8. The luminaire as claimed in claim 6, further comprises: a plurality of numbers and letters removably attached to the one or more of: the housing, and the diffuser lenses.

9. The luminaire as claimed in claim 6, further comprises a removable mounting bracket.

10. The luminaire as claimed in claim 6, further optionally comprising:
a photocell configured to sense natural light level;
compare the natural light level with a predetermined light level; and turn on or turn off the electricity flowing from the terminal block to the lampholder(s), depending upon the natural light level sensed by said photocell.

11. A low voltage luminaire as depicted in FIG. 16, comprising:
a housing with mounting hardware and accessories;
at least two diffuser lenses;
one or more light sources positioned to illuminate the diffuser lenses;
a step-down transformer to reduce the incoming voltage as determined by a light source; and
a terminal block to attach high voltage input wires from an electrical circuit.

12. The luminaire as claimed in claim 11, wherein the housing optionally comprises an on/off switch to control an operation of the luminaire; a timing switch to regulate the period of time the luminaire is illuminated; and an LED controller with a remote control to facilitate the user to alter the color temperature, colors, and functions (such as flashing, pulsing, fading, etc.) of the embodied LEDs.

13. The luminaire as claimed in claim 11, further comprises: a plurality of numbers and letters removably attached to the one or more of: the housing, and the diffuser lenses.

14. The luminaire as claimed in claim 11, further comprising: a removable mounting bracket.

15. The luminaire as claimed in claim 11, further optionally comprising:
a photocell configured to sense natural light level;
compare the natural light level with a predetermined light level; and
turn on or turn off the electricity flowing from the terminal block to the step-down transformer, depending upon the natural light level sensed by said photocell.

16. A low voltage luminaire as depicted in FIG. 24, comprising:
a housing with mounting hardware and accessories;
at least two diffuser lenses;
one or more light sources positioned to illuminate the diffuser lenses; and
an inline step-down transformer to reduce the incoming voltage as determined by a light source.

17. The luminaire as claimed in claim 16, wherein the housing optionally comprises an on/off switch to control an operation of the luminaire; a timing switch to regulate the illuminated time of the luminaire; and an LED controller with a remote control to facilitate the user to alter the color temperature, colors, and functions (such as flashing, pulsing, fading, etc.) of the embodied LEDs.

18. The luminaire as claimed in claim 16, further comprises: a plurality of numbers and letters removably attached to the one or more of: the housing, and the diffuser lenses.

19. The luminaire as claimed in claim 16, further optionally comprising:
a photocell configured to sense natural light level:
compare the natural light level with a predetermined light level; and
turn on or turn off the electricity flowing from the low voltage input wires to the LED controller, depending upon the natural light level sensed by said photocell.
